(19) United States
(12) Patent Application Publication
(10) Pub. No.: US 2026/0301991 A1
(43) Pub. Date: Oct. 1, 2026

(54) WIRING MEMBER AND WIRING SYSTEM

(71) Applicant: SUMITOMO WIRING SYSTEMS, LTD., Mie (JP)

(72) Inventors: Haruka NAKANO, Mie (JP); Takuya KABA, Mie (JP); Kazuhiro NISHIMURA, Mie (JP); Kanji ITO, Mie (JP); Connor Lee MILLS, Mie (JP); Manabu IKI, Mie (JP); Tomohiko TATEISHI, Mie (JP)

(21) Appl. No.: 19/568,076

(22) Filed: Mar. 16, 2026

(30) Foreign Application Priority Data
Mar. 26, 2025 (JP) 2025-051134

(51) Int. Cl. H01B 7/08

(52) U.S. Cl. CPC H01B 7/0823; H01B 7/0876

(57) ABSTRACT

A wiring member includes a path-maintaining wiring group. The path-maintaining wiring group includes a plurality of electric wires, and at least one of the plurality of electric wires is a single-core electric wire having a single-core wire. The path-maintaining wiring group further includes a first parallel fixing portion and a second parallel fixing portion located away from the first parallel fixing portion. Each of the first parallel fixing portion and the second parallel fixing portion maintains the plurality of electric wires including the single-core electric wire in a parallel state.

### CROSS-REFERENCE TO RELATED APPLICATIONS

This application is based on and claims priority from Japanese Patent Application No. 2025-051134, filed on Mar. 26, 2025, with the Japan Patent Office, the disclosure of which is incorporated herein in its entirety by reference.

### TECHNICAL FIELD

The present disclosure relates to a wiring member and a wiring system.

### BACKGROUND

JP 2023-017928 A discloses that a sheet member maintains a plurality of linear transmission members in a bent state.

### SUMMARY

In this regard, it is desirable to make a wiring member have a form close to a flat form and to be able to maintain a predetermined shape with a simpler configuration.

In the view of this, the present disclosure aims to be able to make a wiring member have a form close to a flat form and maintain the wiring member in a predetermined shape with a simpler configuration.

A wiring member according to the present disclosure is a wiring member including a path-maintaining wiring group, wherein the path-maintaining wiring group includes a plurality of electric wires, and at least one of the plurality of electric wires is a single-core electric wire having a single-core wire, the path-maintaining wiring group further includes a first parallel fixing portion and a second parallel fixing portion located apart from the first parallel fixing portion, and each of the first parallel fixing portion and the second parallel fixing portion maintains the plurality of electric wires including the single-core electric wire in a parallel state.

In addition, a wiring system according to the present disclosure is a wiring system including: a trunk line wiring member having a plurality of trunk line connection portions; and a plurality of branch line wiring members having branch line connection portions connected to the trunk line connection portions, wherein the trunk line wiring member is the wiring member according to any one of claims 1 to 3, and the branch line wiring members include a plurality of branch electric wires and a binding member that bundles the plurality of branch electric wires.

According to the present disclosure, with a simpler configuration, the wiring member can be made to have a form close to a flat form, and can be maintained in a predetermined shape.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view showing a wiring member according to Embodiment 1.

FIG. 2 is an exploded view of the wiring member.

FIG. 3 is a cross-sectional view taken along line III-III in FIG. 1.

FIG. 4 is a cross-sectional view taken along line IV-IV in FIG. 1.

FIG. 5 is a diagram illustrating a wiring system according to Embodiment 2.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here [Description of Embodiments of the Present Disclosure]

First, embodiments according to the present disclosure will be listed and described below.

A wiring member according to the present disclosure is as follows.
(1) The wiring member includes a path-maintaining wiring group, wherein the path-maintaining wiring group includes a plurality of electric wires, at least one of the plurality of electric wires is a single-core electric wire having a single-core wire, the path-maintaining wiring group further includes a first parallel fixing portion and a second parallel fixing portion located apart from the first parallel fixing portion, and each of the first parallel fixing portion and the second parallel fixing portion maintains the plurality of electric wires including the single-core electric wire in a parallel state.

According to this wiring member, each of the first parallel fixing portion and the second parallel fixing portion maintains the plurality of electric wires including the single-core electric wire in the parallel state, and thus the wiring member can be made to have a form close to a flat form. In addition, the single-core electric wire can easily maintain a predetermined shape than electric wires including a twisted wire. Therefore, each of the first parallel fixing portion and the second parallel fixing portion maintains a plurality of electric wires including a single-core electric wire in a parallel state, and thus, the wiring member can be more readily maintained in a predetermined shape by the single-core electric wires between the first parallel fixing portion and the second parallel fixing portion. Therefore, even when electric wires are not fixed to a sheet over the entire length in the longitudinal direction, the wiring member can be made to have a form close to a flat form, and can be easily maintained in a predetermined shape with a simpler configuration.
(2) In the wiring member according to (1), all of the plurality of electric wires included in the path-maintaining wiring group may be the single-core electric wires.

When all of the plurality of electric wires included in the path-maintaining wiring group are single-core electric wires in this manner, the path-maintaining wiring group can be more reliably maintained in a predetermined shape. In addition, a plurality of single-core electric wires can be easily maintained in a parallel state between the first parallel fixing portion and the second parallel fixing portion.
(3) In the wiring member according to (2), the plurality of single-core electric wires may be arranged in a parallel state between the first parallel fixing portion and the second parallel fixing portion.

Each of the plurality of single-core electric wires maintains its own shape in this manner, and thus the plurality of single-core electric wires can be arranged in a parallel state between the first parallel fixing portion and the second parallel fixing portion.
(4) In the wiring member according to any one of (1) to (3), the path-maintaining wiring group may include a region in which the plurality of electric wires are in an unrestrained state, between the first parallel fixing portion and the second parallel fixing portion.

This eliminates the need for processing to maintain a plurality of electric wires in a parallel state in this region, and thus a wiring member can be easily manufactured.
(5) In the wiring member according to any one of (1) to (4), the path-maintaining wiring group may include a first end and a second end, the first parallel fixing portion may maintain the plurality of electric wires in a parallel state at the first end, and the second parallel fixing portion may maintain the plurality of electric wires in a parallel state at the second end.

This makes it easier for the plurality of electric wires to be maintained in a parallel state between the first end and the second end of the path-maintaining wiring group.
(6) In the wiring member according to (5), the path-maintaining wiring group may further include an intermediate parallel fixing portion that maintains the plurality of electric wires in a parallel state in a partial region between the first parallel fixing portion and the second parallel fixing portion.

This makes it easier for the intermediate parallel fixing portion to maintain the path-maintaining wiring group in a parallel state.
(7) The wiring member according to any one of (1) to (6) may further include an additional flat wiring group including a plurality of additional electric wires and a sheet to which the plurality of additional electric wires arranged parallel to each other are fixed, wherein the additional flat wiring group may be stacked on the path-maintaining wiring group.

In this case, an electric wire that is likely to bend can be maintained in a parallel state as the additional electric wire using the sheet. In addition, by placing the additional flat wiring group on the path-maintaining wiring group, the path-maintaining wiring group can be easily kept flat. Therefore, the entire wiring member is easily kept flat.
(8) In the wiring member according to (7), all of the plurality of additional electric wires included in the additional flat wiring group may be twisted electric wires having a twisted wire.

This allows a twisted electric wire that is likely to bend to be easily maintained in a parallel state using the sheet.
(9) The wiring member according to (7) or (8) may further include: a first cover; and a second cover, the first cover and the second cover holding the path-maintaining wiring group and the additional flat wiring group.

This makes it easier to maintain a plurality of wiring groups together in a flat state.

A wiring system according to the present disclosure is as follows.
(10) The wiring system includes: a trunk line wiring member having a plurality of trunk line connection portions; and a plurality of branch line wiring members having branch line connection portions connected to the trunk line connection portions, wherein the trunk line wiring member is the wiring member according to any one of (1) to (9), and the branch line wiring member includes a plurality of branch electric wires and a binding member that bundles the plurality of branch electric wires.

In this case, the trunk line wiring member can be easily attached to an assembly target along a predetermined wiring path. The branch line wiring member can be easily bent and connected to a connection destination.

### Details of Embodiments of the Present Disclosure

Specific examples of the wiring member and the wiring system according to the present disclosure will be described below with reference to the drawings. Note that the present disclosure is not limited to these examples, but is indicated by the claims and is intended to include all changes within the meaning and scope of the claims and equivalents.

### Embodiment 1

A wiring member according to Embodiment 1 will be described below.

### Overall Configuration of Wiring Member

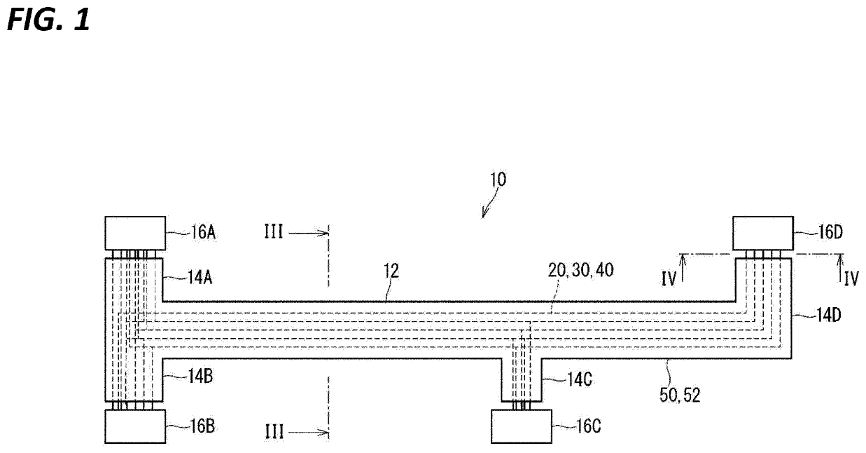

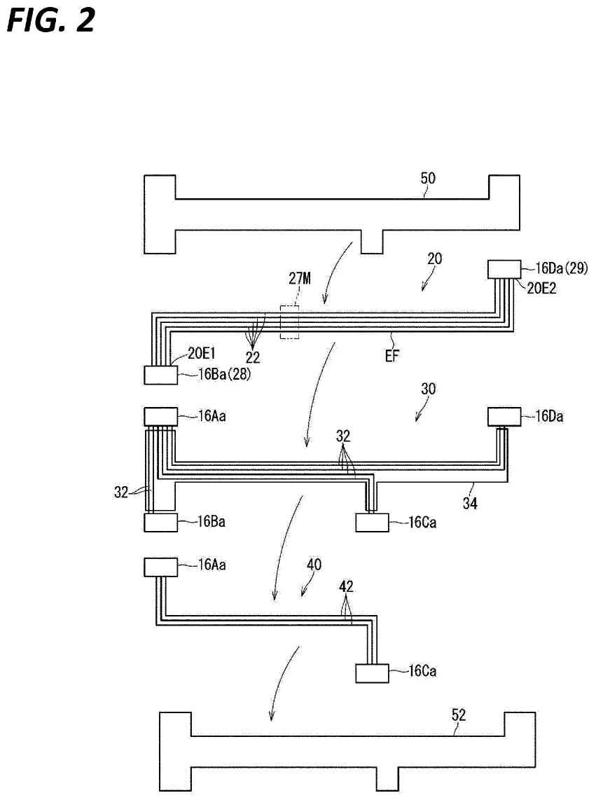

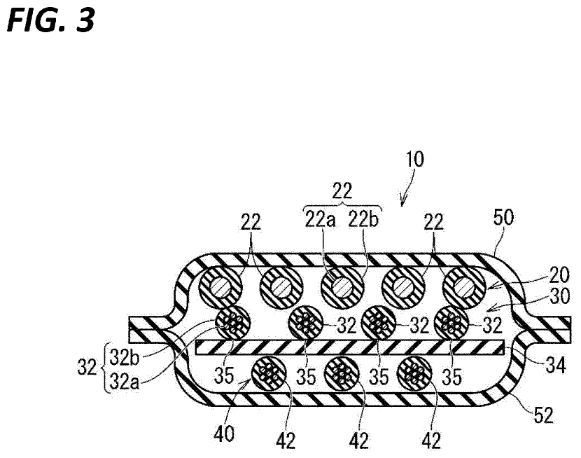

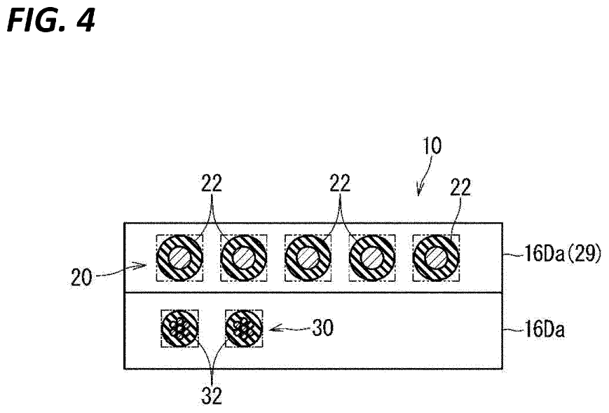

FIG. 1 is a plan view of a wiring member 10. FIG. 2 is an exploded view of the wiring member 10. FIG. 3 is a cross-sectional view taken along line III-III in FIG. 1. FIG. 4 is a cross-sectional view taken along line IV-IV in FIG. 1.

The wiring member 10 is, for example, wiring that electrically connects electrical components to each other in a vehicle. The wiring member 10 is disposed along a path for connecting electrical components together. The wiring member 10 connects at least two electrical components to each other. In this embodiment, the wiring member 10 connects a plurality of (for example, four) electrical components.

The wiring member 10 may have a trunk line 12 and branch lines 14A, 14B, 14C, and 14D that branch off from the trunk line 12. The trunk line 12 is a portion where the largest number of wirings are gathered. For example, branch lines 14A and 14B branch off from one end of the trunk line 12. The branch lines 14A and 14B may extend in opposite directions intersecting a longitudinal direction of the trunk line 12. For example, branch lines 14C and 14D branch off from the other end of the trunk line 12. The branch line 14C extends to one side intersecting the longitudinal direction of the trunk line 12. The branch line 14D further extends from the other end of the trunk line 12 along the longitudinal direction of the trunk line 12, is bent at a position away from the trunk line 12, and extends to the one side intersecting the longitudinal direction of the trunk line 12.

Connectors 16A, 16B, 16C, and 16D are connected to leading ends of the branch lines 14A, 14B, 14C and 14D, respectively. The connectors 16A, 16B, 16C, and 16D are configured such that terminals are housed in connector housings. Any one end of the electric wires 22, 32, and 42 included in the wiring member 10 is connected to the corresponding terminal. When the connectors 16A, 16B, 16C, and 16D are connected to connectors of the electrical components, the electrical components are electrically connected to each other via the wiring member 10.

The paths of the trunk line 12 and the branch lines 14A, 14B, 14C, and 14D in the wiring member 10 are merely examples. The path of the wiring member 10 is set as appropriate according to the positions of the electrical components, and the space available for arranging the wiring member 10, and the like. Also, the number and branching positions of branch lines 14A, 14B, 14C, and 14D that branch off from the trunk line 12 are also examples. The number and branching positions of branch lines 14A, 14B, 14C, and 14D are set as appropriate according to the number of electrical components to be connected, the connection relationships, and the like.

### Path-Maintaining Wiring Group

The wiring member 10 includes a path-maintaining wiring group 20. The path-maintaining wiring group 20 is a wiring group having rigidity suitable for maintaining a path, and, for example, has higher rigidity than an additional flat wiring group 30, which will be described later.

The path-maintaining wiring group 20 includes a plurality of electric wires 22. At least one of the plurality of electric wires 22 is a single-core electric wire 22 having a single-core wire 22a. The single-core wire 22a is a wire whose core wire is constituted by a single conductor. In other words, a twisted wire obtained by twisting together a plurality of bare wires is not a single-core wire 22a. The single-core wire 22a may be a single-core metal wire made of, for example, copper, a copper alloy, aluminum, or an aluminum alloy.

The single-core wire 22a is covered by a coating 22b. The coating 22b may be a resin coating or enamel coating. Therefore, the single-core electric wire 22 may be a covered electric wire covered by resin through extrusion, an enameled wire, or a formal wire.

The single-core wire 22a has a rigidity such that the wire is unlikely to bend compared to a twisted wire. Therefore, the single-core electric wire 22 is also difficult to bend. As a result of the path-maintaining wiring group 20 including at least one single-core electric wire 22, the path-maintaining wiring group 20 also becomes difficult to bend, and can have a rigidity suitable for maintaining the path.

The ratio of the single-core electric wires 22 to the plurality of electric wires included in the path-maintaining wiring group 20 is any ratio. For example, the percentage of the single-core electric wires 22 to the plurality of electric wires included in the path-maintaining wiring group 20 may be 50% or more, 70% or more, or 90% or more. In this embodiment, an example in which all of the plurality of electric wires included in the path-maintaining wiring group 20 are single-core electric wires 22 will be described.

The path-maintaining wiring group 20 further includes a first parallel fixing portion 28 and a second parallel fixing portion 29 located away from the first parallel fixing portion 28. Each of the first parallel fixing portion 28 and the second parallel fixing portion 29 maintains the plurality of single-core electric wires 22 in a parallel state.

In this embodiment, the path-maintaining wiring group 20 includes a first end 20E1 and a second end 20E2. The first parallel fixing portion 28 maintains the plurality of single-core electric wires 22 in a parallel state at the first end 20E1. The second parallel fixing portion 29 maintains the plurality of single-core electric wires 22 in a parallel state at the second end 20E2.

More specifically, the first parallel fixing portion 28 and the second parallel fixing portion 29 are connectors. For example, the connectors 16A, 16B, 16C, and 16D support a plurality of terminals T in parallel within the housings (see FIG. 4). For example, the connector 16D is formed by stacking a plurality of connector divided bodies 16Da. One of the plurality of connector divided bodies 16Da has a cavity for maintaining a plurality of terminals T in a parallel state. The ends of the plurality of single-core electric wires 22 are connected to the plurality of terminals T. The plurality of terminals T are maintained in a parallel state by the connector divided body 16Da, and thus the ends of the plurality of single-core electric wires 22 connected to the plurality of terminals T are maintained in a parallel state. The connector divided body 16Da is an example of the second parallel fixing portion 29. The first parallel fixing portion 28 may also be constituted by a connector.

The first parallel fixing portion and the second parallel fixing portion need only be able to maintain electric wires in a parallel state, and do not need to be connectors. For example, one or both of the first parallel fixing portion and the second parallel fixing portion may be a sheet to which the electric wires are fixed in a parallel state. The electric wires may be fixed to the sheet by fusion or adhesion. For example, one or both of the first parallel fixing portion and the second parallel fixing portion may be a resin protector that maintains electric wires in a parallel state. One or both of the first parallel fixing portion and the second parallel fixing portion may be a linking portion that directly links the electric wires together in a parallel state.

In addition, the first parallel fixing portion and the second parallel fixing portion may maintain intermediate portions in the longitudinal direction of the electric wires in a parallel state instead of the ends of the electric wires.

In this embodiment, the first end 20E1 of the plurality of single-core electric wires 22 is maintained in a parallel state by the first parallel fixing portion 28, and the second end 20E2 is maintained in a parallel state by the second parallel fixing portion 29.

The plurality of single-core electric wires 22 are formed in a shape extending along a predetermined path between the first end 20E1 and the second end 20E2. For example, the plurality of electric wires 22 extend linearly at an intermediate portion in the longitudinal direction, are bent and extend in one direction orthogonal to the intermediate portion in the longitudinal direction at one end, and are bent and extend in the opposite direction orthogonal to the intermediate portion in the longitudinal direction at the other end.

Note that the single-core electric wire 22 can have any shape. The bending points, bending angles, and the like are set as appropriate according to a target path. The single-core electric wire 22 may extend straight without bending.

The single-core electric wire 22 is easily maintained in a predetermined shape due to its own rigidity. For this reason, the path-maintaining wiring group 20 including the single-core electric wire 22 is also easily maintained in a shape extending along the predetermined path.

It is preferable that a plurality of the single-core electric wires 22 are arranged in a parallel state between the first parallel fixing portion 28 and the second parallel fixing portion 29. For example, it is preferable that the plurality of single-core electric wires 22 are arranged in a parallel state between the first parallel fixing portion 28 and the second parallel fixing portion 29 while the order of arrangement in the first parallel fixing portion 28 and the second parallel fixing portion 29 is maintained. In other words, the plurality of single-core electric wires 22 are held in a row in a predetermined arrangement order at the first parallel fixing portion 28. The plurality of single-core electric wires 22 are formed in a shape such that they do not intersect each other at the center in the longitudinal direction and the predetermined arrangement order is maintained. The plurality of single-core electric wires 22 are held in a row in the predetermined arrangement order at the second parallel fixing portion 29. For example, the plurality of single-core electric wires 22 are bent at their respective intermediate portions to maintain the order of arrangement in the first parallel fixing portion 28 and the second parallel fixing portion 29.

The path-maintaining wiring group 20 may include a region EF in which the plurality of single-core electric wires 22 are in an unrestrained state, between the first parallel fixing portion 28 and the second parallel fixing portion 29.

In this embodiment, the entire portion of the path-maintaining wiring group 20 between the first parallel fixing portion 28 and the second parallel fixing portion 29 is the region EF.

The region EF is a region where there is no direct or indirect joint between a plurality of electric wires 22 and each electric wire 22 can move without being restrained by other electric wires 22. However, each electric wire 22 may be subject to shape restraint due to its own rigidity. For example, in the region EF, the electric wires 22 are not joined or linked to another member such as a sheet or film, and the electric wires 22 are not joined or linked to each other. In other words, the region EF is a region where no additional members other than the plurality of electric wires 22 are disposed to maintain the electric wires 22 in a parallel state.

In this embodiment, it is not essential that the entire portion of the path-maintaining wiring group 20 between the first parallel fixing portion 28 and the second parallel fixing portion 29 is the region EF.

For example, the path-maintaining wiring group 20 may further include an intermediate parallel fixing portion 27M that maintains the plurality of single-core electric wires 22 in a parallel state in a partial region between the first parallel fixing portion 28 and the second parallel fixing portion 29 (see the two-dot chain line in FIG. 2).

The intermediate parallel fixing portion 27M need only maintain, for example, the single-core electric wires 22 in a parallel state, and may be, for example, a sheet in which a plurality of electric wires are fixed in a parallel state. The electric wires may be fixed to the sheet by fusion or adhesion. For example, the intermediate parallel fixing portion may be a resin protector that maintains electric wires in a parallel state, or may be a linking portion that directly links the electric wires together in a parallel state.

For example, when the first parallel fixing portion and the second parallel fixing portion are disposed at both ends of the path-maintaining wiring group, and the distance therebetween is so long that it is difficult to maintain a plurality of electric wires in a parallel state, the above intermediate parallel fixing portion 27M may be provided.

### Additional Flat Wiring Group

The wiring member 10 may include a wiring group other than the path-maintaining wiring group 20. In this embodiment, the wiring member 10 further includes an additional flat wiring group 30.

The additional flat wiring group 30 includes a plurality of additional electric wires 32 and a sheet 34.

The additional electric wire 32 means an electric wire that is added to the electric wire 22 of the path-maintaining wiring group 20. The additional electric wire 32 includes a core wire 32a and a coating 32b.

At least one of the plurality of additional electric wires 32 may be a twisted electric wire 32 having a twisted wire 32a as a core wire 32a. The twisted wire 32a is a wire obtained by twisting a plurality of bare wires together. In other words, the twisted wire 32a is not a single-core wire. The twisted wire 32a may be a wire in which bare wires made of, for example, copper, a copper alloy, aluminum, or an aluminum alloy are twisted together.

The twisted wire 32a is covered by a coating 32b. The coating 32b may be a resin coating. For example, the twisted electric wire 32 may be a covered electric wire covered by resin through extrusion.

The twisted wire 32a has a rigidity such that the wire is likely to bend compared to a single-core wire. Therefore, the twisted electric wire 32 is also likely to bend.

The ratio of the twisted electric wires 32 to the plurality of electric wires included in the additional flat wiring group 30 is any ratio. For example, the percentage of the twisted electric wires 32 to the plurality of electric wires included in the additional flat wiring group 30 may be 50% or more, 70% or more, or 90% or more. In this embodiment, an example in which all of the plurality of electric wires included in the additional flat wiring group 30 are twisted electric wires 32 will be described.

The sheet 34 is a flat member. The sheet 34 may have a single-layer structure or a multi-layer structure. When the sheet 34 has a multi-layer structure, it is preferable that a fusion layer suitable for fusion with the twisted electric wire 32 is present on at least one main surface of the sheet.

The sheet 34 may contain a resin layer or a metal layer. The sheet 34 may have a non-woven layer of intertwined fibers.

The sheet 34 may be a flexible member. For example, the sheet may be bendable in the thickness direction according to the surface shape of a sheet arrangement target.

The sheet 34 is formed in a shape corresponding to the path of the additional electric wires 32. In this embodiment, the plurality of additional electric wires 32 extend along the path from the trunk line 12 toward the plurality of branch lines 14A, 14B, 14C, and 14D in the wiring member 10. The sheet 34 is also formed in a shape along the trunk line 12 and the plurality of branch lines 14A, 14B, 14C and 14D. The plurality of additional electric wires 32 are fixed to the sheet 34 in a parallel state along a predetermined path. On the sheet 34, the plurality of additional electric wires 32 may extend so as not to intersect each other, but may intersect each other. On the sheet 34, adjacent additional electric wires 32 may or may not be in contact with each other.

The additional electric wires 32 are fixed to the sheet 34 via fixing portions 35. The fixing portions 35 are formed by directly fixing the contact portions (contact portion direct fixing). The contact portion direct fixing means that contact portions of two members to be fixed are directly attached and fixed to each other without using an adhesive or the like provided separately. It is conceivable that, in the contact portion direct fixing, for example, the resin contained in at least one of the two members to be fixed is melted, thereby causing the members to stick together and be fixed.

When such a contact portion direct fixing state is realized, the resin may be, for example, melted by heat or by a solvent. In other words, the contact portion direct fixing state may be a contact portion direct fixing state by heat or a contact portion direct fixing state by a solvent. Preferably, the contact portion direct fixing state is realized by heat.

In this case, the means for realizing the contact portion direct fixing state is not particularly limited, and well-known means such as bonding, fusion, welding, or the like can be used. For example, when realizing the contact portion direct fixing state by heat through bonding, various bonding means such as ultrasonic bonding, heat and pressure bonding, hot air bonding, and high-frequency bonding can be used. Also, when the contact portion direct fixing state is realized by these means, the two members to be fixed are brought into the contact portion direct fixing state by the means. Specifically, for example, when the contact portion direct fixing state is realized by ultrasonic bonding, the two members to be fixed are in the contact portion direct fixing state by ultrasonic bonding.

In this additional flat wiring group 30, the plurality of additional electric wires 32 are fixed to the sheet 34 in the parallel state, thus maintaining the additional electric wires 32 in the flat state. The additional flat wiring group 30 also has a flat form.

Even when the plurality of additional electric wires 32 are the twisted electric wires 32, the additional electric wires 32 are maintained by the sheet 34 in the parallel state and are also maintained by the sheet 34 in a state extending along a predetermined path.

The additional flat wiring group 30 is stacked on the path-maintaining wiring group 20. The stacked body of the path-maintaining wiring group 20 and the additional flat wiring group 30 is also maintained in a flat form as a whole.

### Other Wiring Group

The wiring member 10 may further include a wiring group 40. The wiring group 40 may be configured to include electric wires having a single-core wire, similar to the path-maintaining wiring group 20, or may be configured to include a plurality of electric wires fixed to a sheet in a parallel state, similar to the additional flat wiring group 30.

That is, the wiring member may be configured to include a plurality of path-maintaining wiring groups, or may be configured to include a plurality of additional flat wiring groups.

The wiring member may include a wiring group having a configuration different from those of the path-maintaining wiring group and the additional flat wiring group. For example, as in this embodiment, the wiring group 40 includes twisted electric wires 42 having twisted wires. The twisted electric wires 42 do not have to be maintained in a parallel state by the sheet.

For example, the wiring member may include a layer constituted by an FPC (Flexible Flat Cable) or FFCs (Flexible Printed Circuits).

### Maintaining Stacked State

The wiring groups 20, 30 and 40 are maintained in a stacked state.

For example, connector divided bodies 16Aa, 16Ba, 16Ca, and 16Da at the ends of the wiring groups 20, 30, and 40 are combined, thus maintaining the ends of the wiring groups 20, 30, and 40 in a stacked state. This allows the intermediate portions of the wiring groups 20, 30, and 40 are also maintained in a stacked state.

The stacked body of the wiring groups 20, 30, and 40 may be held between a first cover 50 and a second cover 52.

For example, the first cover 50 and the second cover 52 are flat members. The same members as those mentioned as examples regarding the sheet 34 can be used as the first cover 50 and the second cover 52.

The first cover 50 and the second cover 52 are formed in a shape corresponding to the stacked body of the wiring groups 20, 30, and 40, and protruding from both sides of the stacked body.

In the state where the first cover 50 and the second cover 52 hold the stacked body of the wiring groups 20, 30, and 40, the side edges of the first cover 50 and the second cover 52 protrude outward from both side edges of the stacked body. The side edges of the first cover 50 and the second cover 52 are joined together. The first and second covers are joined through, for example, contact portion direct fixing. For example, the side edges of the first cover 50 and the second cover 52 are ultrasonically joined together.

Between the first cover 50 and the second cover 52, the wiring groups 20, 30, and 40 are easily maintained in the stacked state, and the wiring group 40 is easily maintained in the flat state.

### Effects and the Like

According to the wiring member 10 configured as above, each of the first parallel fixing portion 28 and the second parallel fixing portion 29 maintains a plurality of electric wires including the single-core electric wire 22 in the parallel state, and thus the wiring member 10 can be made to have a form close to a flat form. In addition, the single-core electric wires 22 can easily maintain a predetermined shape than electric wires including twisted wires. Therefore, each of the first parallel fixing portion 28 and the second parallel fixing portion 29 maintains a plurality of electric wires including the single-core electric wires 22 in a parallel state, and thus, the wiring member 10 can be easily maintained in a predetermined shape by the single-core electric wires 22 between the first parallel fixing portion 28 and the second parallel fixing portion 29. Therefore, even when the electric wires 22 are not maintained in a parallel state by being fixed to a sheet over the entire length in the longitudinal direction, the wiring member 10 can be made to have a form close to a flat form, and can be maintained in a predetermined shape with a simpler configuration. This also makes it possible to reduce the cost of the wiring member 10 and simplify manufacturing equipment. In addition, the single-core electric wires 22 do not require a process for twisting bare wires together, and therefore the single-core electric wires 22 can be easily manufactured.

In addition, when all of the plurality of electric wires included in the path-maintaining wiring group 20 are single-core electric wires 22, the path-maintaining wiring group 20 can be more reliably maintained in a predetermined shape. In addition, the plurality of single-core electric wires 22 can be easily maintained in a parallel state between the first parallel fixing portion 28 and the second parallel fixing portion 29.

Each of the plurality of single-core electric wires 22 maintains its own shape, and thus the plurality of single-core electric wires 22 can be arranged in a parallel state between the first parallel fixing portion 28 and the second parallel fixing portion 29.

When a region in which the plurality of electric wires 22 are not restrained by each other is present between the first parallel fixing portion 28 and the second parallel fixing portion 29, processing for maintaining the plurality of electric wires 22 in a parallel state can be omitted in the region, and the wiring member 10 can be easily manufactured.

Also, since the first parallel fixing portion 28 maintains a plurality of electric wires 22 in a parallel state at the first end 20E1, and the second parallel fixing portion 29 maintains a plurality of electric wires 22 in a parallel state at the second end 20E2, the plurality of electric wires 22 can be easily maintained in a parallel state between the first end 20E1 and the second end 20E2 of the path-maintaining wiring group 20.

Also, as a result of the path-maintaining wiring group 20 further including the intermediate parallel fixing portion 27M that maintains the plurality of electric wires 22 in a parallel state in a partial region between the first parallel fixing portion 28 and the second parallel fixing portion 29, the electric wires 22 of the path-maintaining wiring group 20 can be easily maintained in the parallel state.

The wiring member 10 further includes the additional flat wiring group 30 including a plurality of additional electric wires 32 and the sheet 34 to which the plurality of additional electric wires 32 that are arranged parallel to each other are fixed, and the additional flat wiring group 30 is stacked on the path-maintaining wiring group 20. Thus, electric wires that are likely to bend, such as twisted electric wires, can be maintained in a parallel state by the sheet 34 as the additional electric wires 32. In addition, by placing the additional flat wiring group 30 on the path-maintaining wiring group 20, the path-maintaining wiring group 20 can be more easily kept flat. Therefore, the entire wiring member 10 is easily kept flat.

Also, when all of the plurality of additional electric wires included in the additional flat wiring group 30 are twisted electric wires 32 having twisted wires, the twisted electric wires 32 that are likely to bend can be maintained in a parallel state by the sheet 34.

Furthermore, the path-maintaining wiring group 20 and the additional flat wiring group 30 are held between the first cover and the second cover, and thus a plurality of wiring groups 20 and 30 can be easily kept together in the flat state.

### Embodiment 2

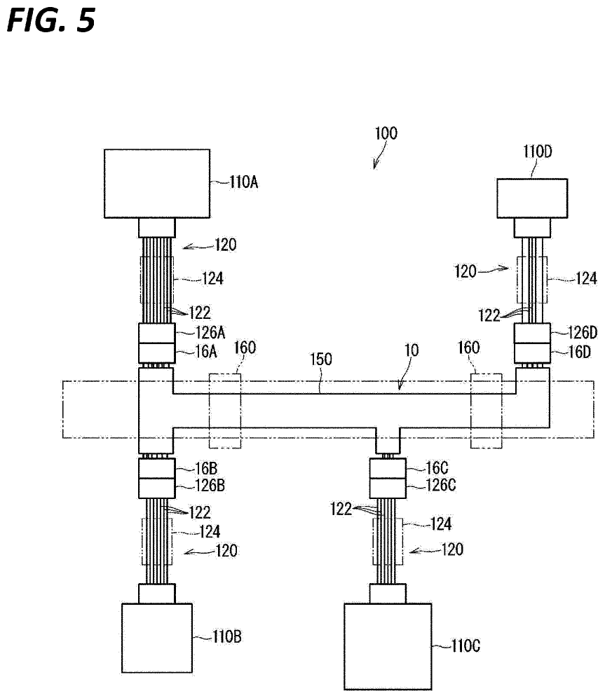

A wiring system 100 according to Embodiment 2 will be described below. FIG. 5 is a diagram illustrating the wiring system 100 according to Embodiment 2. In this embodiment, the wiring system 100, which is applied around a reinforcement 150 in a vehicle, will be described.

The reinforcement 150 is an elongate member for reinforcement in a vehicle, and is disposed, for example, in front of an instrument panel and along the width direction of the vehicle.

Various devices 110A, 110B, 110C, and 110D are disposed around the reinforcement 150. Examples of various devices include a meter device, a center console device, an ECU (electronic control unit), and a door device.

The wiring system 100 includes a trunk line wiring member 10 and a plurality of branch line wiring members 120.

The trunk line wiring member 10 is the wiring member 10 described in Embodiment 1. The trunk line wiring member 10 includes connectors 16A, 16B, 16C, and 16D as a plurality of branch line connection portions.

The plurality of branch line wiring members 120 each have a connector 126A, 126B, 126C, or 126D as a branch line connection portion connected to the connector 16A, 16B, 16C, or 16D.

Each branch line wiring member 120 includes the plurality of branch electric wires 122 and a binding member 124 that bundles the plurality of branch electric wires 122.

Each branch electric wire 122 may be a single-core electric wire having a single-core wire or may be a twisted electric wire including a twisted wire. The higher the percentage of the twisted electric wires among the electric wires included in the branch line wiring member 120, the more easily the branch line wiring member 120 can be bent. The percentage of the twisted electric wires among the electric wires included in the branch line wiring member 120 may be 50% or more, 70% or more, 90% or more, or 100%.

The binding member 124 may be adhesive tape wound around the plurality of branch electric wires 122 or may be a cable tie. The binding member 124 may be a corrugated tube fitted around the plurality of branch electric wires 122 or a resin sheet.

As a result of the plurality of branch electric wires 122 being bundled by the binding member 124, the branch electric wires 122 are less likely to come apart, and the branch electric wires 122 can be readily disposed along a predetermined path.

The trunk line wiring member 10 is disposed, for example, along the reinforcement 150 and fixed to the reinforcement 150. For example, in a state where the trunk line wiring member 10 is disposed along the reinforcement 150, a fixing member such as the binding member 160 keeps the trunk line wiring member 10 fixed to the reinforcement 150. The trunk line wiring member 10 may also be fixed to the reinforcement 150 using a clip, a screw, or the like.

The branch line wiring members 120 are disposed to connect the trunk line wiring member 10 disposed along the reinforcement 150 and various devices 110A, 110B, 110C, and 110D located away from the reinforcement 150.

That is, each of the connectors 126A, 126B, 126C, and 126D of the branch line wiring members 120 is connected to one of the connectors 16A, 16B, 16C, and 16D. The branch line wiring members 120 extend from the trunk line wiring member 10 disposed along the reinforcement 150 toward the various devices 110A, 110B, 110C, and 110D, and are connected to the various devices 110A, 110B, 110C, and 110D via connectors or the like.

Between the reinforcement 150 and various devices 110A, 110B, 110C, and 110D, it may be necessary to perform a routing operation such as moving the branch line wiring members 120 to various orientations or passing the branch line wiring members through narrow points.

When the branch line wiring members 120 can be more easily bent than the trunk line wiring member 10, the above routing operation will be easily performed.

### Effects

According to Embodiment 2, the trunk line wiring member 10 can be easily attached to an assembly target along a predetermined wiring path. For example, the trunk line wiring member 10 is easily fixed along a path along the reinforcement 150. Since the trunk line wiring member 10 maintains a flat form on the reinforcement 150, even when there is another component, such as an instrument panel, near the reinforcement 150, the trunk line wiring member 10 can be easily placed in a narrow space between the reinforcement 150 and the other component.

In addition, by bending the branch line wiring member 120, it is possible to easily perform the routing and connection operation for various devices to which the branch line wiring members 120 are connected.

The trunk line wiring member 10 may be applied not only to the reinforcement 150 but also to a floor, a roof interior material, an inner panel of a door, or the like, when it is disposed along a certain path.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A wiring member comprising:
a path-maintaining wiring group,
wherein the path-maintaining wiring group includes a plurality of electric wires,
at least one of the plurality of electric wires is a single-core electric wire having a single-core wire,
the path-maintaining wiring group further includes a first parallel fixing portion and a second parallel fixing portion located away from the first parallel fixing portion, and
each of the first parallel fixing portion and the second parallel fixing portion maintains the plurality of electric wires including the single-core electric wire in a parallel state.

2. The wiring member according to claim 1,
wherein all of the plurality of electric wires included in the path-maintaining wiring group are the single-core electric wires.

3. The wiring member according to claim 2,
wherein the plurality of single-core electric wires are arranged in a parallel state between the first parallel fixing portion and the second parallel fixing portion.

4. The wiring member according to claim 1,
wherein the path-maintaining wiring group includes a region in which the plurality of electric wires are in an unrestrained state, between the first parallel fixing portion and the second parallel fixing portion.

5. The wiring member according to claim 1,
wherein the path-maintaining wiring group includes a first end and a second end,
the first parallel fixing portion maintains the plurality of electric wires in a parallel state at the first end, and
the second parallel fixing portion maintains the plurality of electric wires in a parallel state at the second end.

6. The wiring member according to claim 5,
wherein the path-maintaining wiring group further includes an intermediate parallel fixing portion that maintains the plurality of electric wires in a parallel state in a partial region between the first parallel fixing portion and the second parallel fixing portion.

7. The wiring member according to claim 1, further comprising:
an additional flat wiring group including a plurality of additional electric wires and a sheet to which the plurality of additional electric wires arranged parallel to each other are fixed,
wherein the additional flat wiring group is stacked on the path-maintaining wiring group.

8. The wiring member according to claim 7,
wherein all of the plurality of additional electric wires included in the additional flat wiring group are twisted electric wires having a twisted wire.

9. The wiring member according to claim 7, further comprising:
a first cover; and
a second cover,
the first cover and the second cover holding the path-maintaining wiring group and the additional flat wiring group.

10. A wiring system comprising:
a trunk line wiring member having a plurality of trunk line connection portions; and
a plurality of branch line wiring members having branch line connection portions connected to the trunk line connection portions,
wherein the trunk line wiring member is the wiring member according to claim 1, and the branch line wiring member includes a plurality of branch electric wires and a binding member that bundles the plurality of branch electric wires.
